(19) United States
(12) Patent Application Publication
(10) Pub. No.: US 2024/0204234 A1
(43) Pub. Date: Jun. 20, 2024

(54) METHOD OF MANUFACTURING POWER STORAGE CELL

(71) Applicant: Toyota Jidosha Kabushiki Kaisha, Toyota-shi (JP)

(72) Inventor: Kenichi KAKISHITA, Nagoya-shi (JP)

(73) Assignee: Toyota Jidosha Kabushiki Kaisha, Toyota-shi (JP)

(21) Appl. No.: 18/543,758

(22) Filed: Dec. 18, 2023

(30) Foreign Application Priority Data
Dec. 20, 2022 (JP) 2022-203441

(51) Int. Cl. H01M 10/04; H01M 10/625

(52) U.S. Cl. CPC H01M 10/0422; H01M 10/0431; H01M 10/625; H01M 2220/20

(57) ABSTRACT

A method of manufacturing a power storage cell includes: a preparing step of preparing an electrode sheet including a current collecting foil and an active material layer; a bending step of bending the current collecting foil to form a bent piece; a cutting step of forming cuts in the bent piece to form connecting pieces separated from each other; and a winding step of winding the electrode sheet around a winding core. The current collecting foil prepared in the preparing step includes a main region provided with the active material layer and an end region not provided with the active material layer. In the bending step, the end region is bent with respect to the main region to form the bent piece in the end region. In the winding step, the electrode sheet is wound with each of the connecting pieces leaning toward the winding core.

### CROSS REFERENCE TO RELATED APPLICATIONS

This nonprovisional application is based on Japanese Patent Application No. 2022-203441 filed on Dec. 20, 2022 with the Japan Patent Office, the entire contents of which are hereby incorporated by reference.

### BACKGROUND

### Field

The present disclosure relates to a method of manufacturing a power storage cell.

### Description of the Background Art

Japanese Patent No. 4401634 discloses a rechargeable battery including an electrode plate group that includes a positive electrode plate, a negative electrode plate, and a separator, and a battery case that houses the electrode plate group. A plurality of cuts are formed in a strip-shaped current collecting portion of each electrode plate. The strip-shaped current collecting portion has a plurality of connecting pieces each formed between the cuts. These electrode plates are spirally wound with the separator interposed therebetween to form the group of electrode plates.

### SUMMARY

In the case of the method of manufacturing a power storage cell described in Japanese Patent No. 4401634, when each electrode plate is spirally wound with the separator interposed, the connecting piece may lean in a direction away from the winding core (outward in the radial direction of the winding core).

It is an object of the present disclosure to provide a method of manufacturing a power storage cell as well as a power storage cell that enable prevention of the connecting piece from leaning in the direction away from the winding core during winding.

A method of manufacturing a power storage cell according to one aspect of the present disclosure includes: a preparing step of preparing an electrode sheet, the electrode sheet including a current collecting foil having a shape elongated in one direction, and an active material layer provided on a surface of the current collecting foil; a bending step of bending the current collecting foil to form a bent piece; a cutting step of forming a plurality of cuts in the bent piece to form a plurality of connecting pieces separated from each other in the one direction; and a winding step of winding the electrode sheet around a winding core, wherein the current collecting foil of the electrode sheet prepared in the preparing step includes a main region provided with the active material layer, and an end region that is not provided with the active material layer and has a shape continuous in the one direction, in the bending step, the end region is bent with respect to the main region to form the bent piece in the end region, and in the winding step, the electrode sheet is wound in a state in which each of the plurality of connecting pieces leans toward the winding core.

These and other objects, features, aspects and advantages of the disclosure will become apparent from the following detailed description of the disclosure, which is understood in conjunction with the accompanying drawings.

### BRIEF DESCRIPTION OF THE DRAWINGS

FIG. 1 is a partial cross-sectional view schematically showing a power storage cell according to an embodiment of the present disclosure.

FIG. 2 is a cross-sectional view schematically showing a positive electrode sheet before winding.

FIG. 3 is a cross-sectional view schematically showing a bending step.

FIG. 4 is a cross-sectional view schematically showing a cutting step.

FIG. 5 is a perspective view schematically showing a positive electrode sheet before a winding step.

### DESCRIPTION OF THE PREFERRED EMBODIMENTS

Embodiments of the present disclosure will be described with reference to the drawings. In the drawings referred to below, the same or corresponding members are denoted by the same reference numerals.

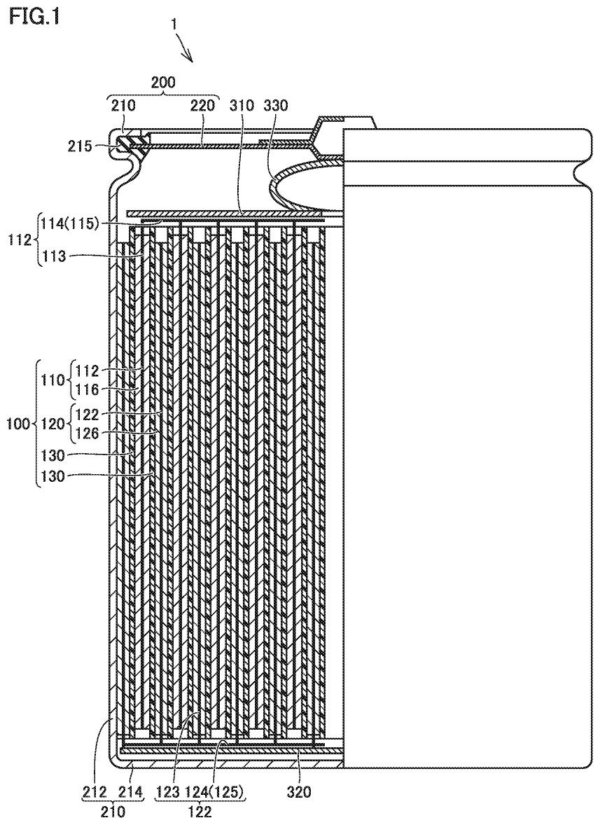

FIG. 1 is a partial cross-sectional view schematically showing a power storage cell according to an embodiment of the present disclosure. The power storage cell 1 is preferably mounted on a vehicle.

As shown in FIG. 1, the power storage cell 1 includes an electrode assembly 100, a cell case 200, a positive electrode current collector plate 310, a negative electrode current collector plate 320, and a coupling lead 330.

The electrode assembly 100 includes a positive electrode sheet 110, a negative electrode sheet 120, and a separator 130. The electrode assembly 100 is a wound body formed by winding a positive electrode sheet 110 and a negative electrode sheet 120 with a separator 130 interposed therebetween.

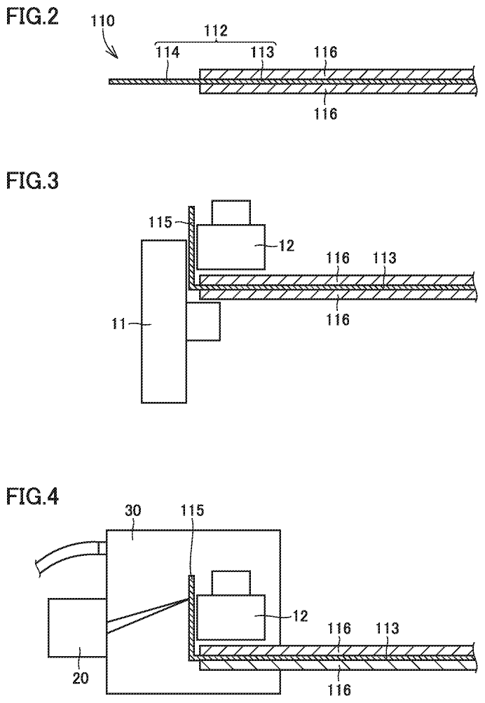

FIG. 2 is a cross-sectional view schematically showing a positive electrode sheet before winding. As shown in FIGS. 1 and 2, the positive electrode sheet 110 includes a positive electrode current collecting foil 112 and a positive electrode active material layer 116.

The positive electrode current collecting foil 112 is made of a metal such as aluminum. The positive electrode current collecting foil 112 has a main region 113 and an end region 114.

The main region 113 is a region in which the positive electrode active material layer 116 is provided in the positive electrode current collecting foil 112. The main region 113 is arranged to overlap with itself in the radial direction of the wound body (electrode assembly 100).

The end region 114 is a region in which the positive electrode active material layer 116 is not provided in the positive electrode current collecting foil 112. As shown in FIG. 1, the end region 114 is formed outside (upper side in FIG. 1) the main region 113 in the axial direction (vertical direction in FIG. 1) of the electrode assembly 100. The end region 114 has a bent piece 115 that is bent inward in the radial direction.

The bent piece 115 of the end region 114 has a plurality of connecting pieces 115a (see FIG. 3) separated from each other in the circumferential direction of the electrode assembly 100. Each connecting piece 115a leans inward in the radial direction. The upper surface of each connecting piece 115a forms a substantially flat surface.

The negative electrode sheet 120 includes a negative electrode current collecting foil 122 made of a metal such as copper, and a negative electrode active material layer 126 provided on the surface of the negative electrode current collecting foil 122.

The structure of the negative electrode current collecting foil 122 is substantially the same as the structure of the positive electrode current collecting foil 112. Therefore, the description of the negative electrode current collecting foil 122 is simplified. That is, the negative electrode current collecting foil 122 has a main region 123 in which the negative electrode active material layer 126 is provided, and an end region 124 formed on the outside (lower side in FIG. 1) of the main region 123 in the axial direction. The end region 124 has a bent piece 125, and the bent piece 125 has a plurality of connecting pieces (not shown) separated from each other in the circumferential direction.

The separator 130 is disposed between the positive electrode sheet 110 and the negative electrode sheet 120. More specifically, the separator 130 is disposed only between the main region 113 of the positive electrode sheet 110 and the main region 123 of the negative electrode sheet 120 adjacent to each other in the radial direction. The separator 130 is made of an insulating material and allows penetration of ions.

The cell case 200 houses the electrode assembly 100. The cell case 200 also contains an electrolyte solution (not shown). The cell case 200 is sealed. The cell case 200 includes a case body 210 and a lid 220.

The case body 210 opens upward. The case body 210 is made of metal such as aluminum. The case body 210 includes a bottom wall 212 and a peripheral wall 214. The bottom wall 212 is formed in a disc shape. The peripheral wall 214 rises from the edge of the bottom wall 212 and is formed in a cylindrical shape.

The lid 220 closes the opening of the case body 210. The lid 220 is connected to the case body 210 via a sealing member 215.

The positive electrode current collector plate 310 is disposed above the electrode assembly 100. The positive electrode current collector plate 310 is connected to the upper surface of each connecting piece 115a of the positive electrode current collecting foil 112 by welding or the like.

The negative electrode current collector plate 320 is disposed below the electrode assembly 100. The negative electrode current collector plate 320 is connected to an upper surface of each connecting piece of the negative electrode current collecting foil 122 by welding or the like.

The coupling lead 330 connects the positive electrode current collector plate 310 and the lid 220.

Next, a method of manufacturing the power storage cell 1 will be described with reference to FIGS. 2 to 5. This manufacturing method includes a preparing step, a bending step, a cutting step, and a winding step. Hereinafter, the positive electrode sheet 110 and the negative electrode sheet 120 are referred to as “electrode sheet”, the positive electrode current collecting foil 112 and the negative electrode current collecting foil 122 are referred to as “current collecting foil”, and the positive electrode active material layer 116 and the negative electrode active material layer 126 are referred to as “active material layer”. In FIGS. 2 to 5, the positive electrode sheet 110 is shown as an example.

In the preparing step, an electrode sheet is prepared. Specifically, in the preparing step, an electrode sheet including a current collecting foil having a shape elongated in one direction (a direction orthogonal to the plane of FIG. 2) and an active material layer provided on the surface of the current collecting foil is prepared. The respective current collecting foils of the electrode sheets 110 and 120 prepared in the preparing step include main regions 113 and 123 and end regions 114 and 124. The main regions 113 and 123 are formed, for example, by providing an active material layer on a current collecting foil conveyed by a conveying roll. The end regions 114 and 124 are adjacent to the main regions 113 and 123 in the orthogonal direction (the left-right direction in FIG. 2) orthogonal to both the one direction and the thickness direction of the current collecting foil. The lengths of the main regions 113 and 123 in the orthogonal direction are set to 80 mm, for example, and the lengths of the end regions 114 and 124 in the orthogonal direction are set to 5 mm, for example. The end regions 114 and 124 are in a shape continuous in one direction.

In the bending step, a bent piece 115 is formed by bending the current collecting foil. Specifically, in the bending step, the end region 114 is bent with respect to the main region 113 so that the bent piece 115 is formed in the end region 114.

As shown in FIG. 3, in the bending step, a bending roller 11 and a receiving roller 12 are used. The bending roller 11 bends the end regions 114 and 124 in a direction orthogonal to the end regions 114 and 124 (upward in FIG. 3). The bending roller 11 bends the end regions 114 and 124 of the electrode sheet conveyed by the conveying roll. The receiving roller 12 receives the bent piece 115 bent by the bending roller 11. The receiving roller 12 guides the bent piece 115 along a conveying direction of the electrode sheet (a direction orthogonal to the plane of FIG. 3) while receiving the bent piece 115. The position of the bending roller 11 and the position of the receiving roller 12 may be fixed.

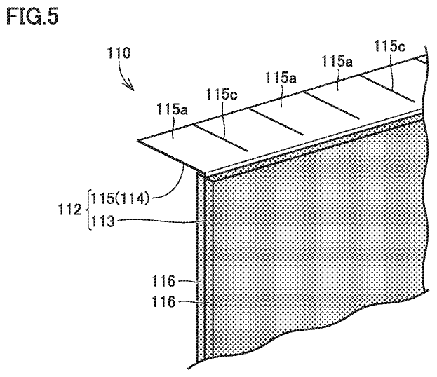

In the cutting step, by forming a plurality of cuts 115c (see FIG. 5) in the bent piece 115, a plurality of connecting pieces 115a (see FIG. 5) separated from each other in one direction are formed. As shown in FIG. 4, in the cutting step, a plurality of cuts 115c are formed in the bent piece 115 by irradiating the bent piece 115 received by the receiving roller 12 with laser radiation from the laser irradiation unit 20. Each cut 115c may be formed parallel to the orthogonal direction. Each cut 115c may be formed by a blade. FIG. 5 shows the positive electrode sheet 110 of the electrode sheet after the cutting step.

In the winding step, the electrode sheet and the separator 130 are wound around a winding core (not shown). In the winding step, the electrode sheet is wound in a state in which each of the plurality of connecting pieces 115a leans toward the winding core. The electrode sheet is wound around the winding core at a position where the active material layer overlaps the winding core. The separator 130 is disposed at a position overlapping only the main regions 113 and 123.

As described above, in the method of manufacturing the power storage cell 1 according to the present embodiment, before the winding step, the bent pieces 115 are formed in the end regions 114 and 124 in the bending step, and the plurality of connecting pieces 115a are formed in the bent piece 115 in the cutting step, so that each of the connecting pieces 115a is prevented from leaning in the direction away from the winding core (outward in the radial direction of the winding core) in the winding step.

It will be appreciated by those skilled in the art that the exemplary embodiments described above are specific examples of the following aspects.

### [Aspect 1]

A method of manufacturing a power storage cell, the method including:
a preparing step of preparing an electrode sheet, the electrode sheet including a current collecting foil having a shape elongated in one direction, and an active material layer provided on a surface of the current collecting foil;
a bending step of bending the current collecting foil to form a bent piece;
a cutting step of forming a plurality of cuts in the bent piece to form a plurality of connecting pieces separated from each other in the one direction; and
a winding step of winding the electrode sheet around a winding core, wherein
the current collecting foil of the electrode sheet prepared in the preparing step includes a main region provided with the active material layer, and an end region that is not provided with the active material layer and has a shape continuous in the one direction,
in the bending step, the end region is bent with respect to the main region to form the bent piece in the end region, and
in the winding step, the electrode sheet is wound in a state in which each of the plurality of connecting pieces leans toward the winding core.

According to this method of manufacturing a power storage cell, before the winding step, the bent piece is formed in the end region in the bending step, and a plurality of connecting pieces are formed in the bent piece in the cutting step, so that each of the connecting pieces is prevented from leaning in the direction away from the winding core (outward in the radial direction of the winding core) in the winding step.

### [Aspect 2]

The method of manufacturing a power storage cell according to Aspect 1, wherein the bending step is performed using a bending roller for bending the end region and a receiving roller for receiving the bent piece bent by the bending roller.

### [Aspect 3]

The method of manufacturing a power storage cell according to Aspect 2, wherein in the cutting step, laser irradiation is applied to the bent piece received by the receiving roller to form the plurality of cuts in the bent piece.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A method of manufacturing a power storage cell, the method comprising:
a preparing step of preparing an electrode sheet, the electrode sheet including a current collecting foil having a shape elongated in one direction, and an active material layer provided on a surface of the current collecting foil;
a bending step of bending the current collecting foil to form a bent piece;
a cutting step of forming a plurality of cuts in the bent piece to form a plurality of connecting pieces separated from each other in the one direction; and
a winding step of winding the electrode sheet around a winding core, wherein
the current collecting foil of the electrode sheet prepared in the preparing step includes a main region provided with the active material layer, and an end region that is not provided with the active material layer and has a shape continuous in the one direction,
in the bending step, the end region is bent with respect to the main region to form the bent piece in the end region, and
in the winding step, the electrode sheet is wound in a state in which each of the plurality of connecting pieces leans toward the winding core.

2. The method of manufacturing a power storage cell according to claim 1, wherein the bending step is performed using a bending roller for bending the end region and a receiving roller for receiving the bent piece bent by the bending roller.

3. The method of manufacturing a power storage cell according to claim 2, wherein in the cutting step, laser irradiation is applied to the bent piece received by the receiving roller to form the plurality of cuts in the bent piece.
